(19) United States
(12) Patent Application Publication
(10) Pub. No.: US 2005/0111404 A1
(43) Pub. Date: May 26, 2005

(54) Wireless communication apparatus, method and program therefor

(75) Inventors: Hideya Tabeta, Kanagawa (JP); Yutaka Inoue, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/952,884

(22) Filed: Sep. 30, 2004

(30) Foreign Application Priority Data
Oct. 1, 2003 (JP) 2003-343719 (PAT.

(51) Int. Cl. G10L 19/14

(52) U.S. Cl. 370/328; 370/352; 370/401

(57) ABSTRACT

A wireless communication apparatus is provided with a fax (facsimile machine) with a telephone function accommodating a public line, and a slave apparatus (cordless handset) capable of wireless communication with the fax, wherein the fax has a function of synthesizing a speech from character data and outputting a speech signal. The fax executes a speech synthesis of the character data based on the character data transmitted from the slave apparatus to the fax and the slave apparatus outputs a speech based on a speech signal transmitted from the fax. As above-mentioned, the present invention enables a read-out of character data stored in a slave apparatus without loading the slave apparatus with a speech synthesizing function, and a program therefor.

### BACKGROUND OF THE INVENTION

1. Field of the Invention

The present invention relates to a wireless communication apparatus and method, and a program therefor, and more particularly to a wireless communication apparatus and method, and a program therefor having a speech synthesizing function for reading out a mail, at the transmission and reception of the mail through a public line.

2. Related Background Art

There is already known a communication apparatus in which a master apparatus accommodating a public line has a speech synthesizing function and, in response to a request from a slave apparatus, executes a conversion of character data, stored in advance in a memory, into a speech signal for transmission to the slave apparatus (for example, Japanese Patent Application Laid-open No. 2001-197540).

Also there is proposed a communication apparatus in which a slave apparatus has a speech synthesizing function and reads out name data in a telephone directory, in response to a received telephone number of a destination (for example, Japanese Patent Application Laid-open No. H6-164712).

However, the master apparatus in Japanese Patent Application Laid-open No. 2001-197540 can transfer the speech signal by the speech synthesizing function thereof to the slave apparatus, but cannot read out mail data or telephone directory data stored in the slave apparatus, since the character data for speech synthesis are stored only in the master apparatus.

Also the slave apparatus in Japanese Patent Application Laid-open No. H6-164712 can read out of the telephone directory data etc., by the speech synthesizing function thereof, but the magnitude in the circuit is increased by the addition of the speech synthesizing function, thereby leading an increased cost.

### SUMMARY OF THE INVENTION

An object of the present invention is to provide wireless communication apparatus and method and a program therefor enabling a read-out of the character data stored in a slave apparatus without providing the slave apparatus with a speech synthesizing function.

### BRIEF DESCRIPTION OF THE DRAWINGS

FIG. 1 is a view showing a schematic configuration of a wireless communication apparatus embodying the present invention.

FIG. 2 is a block diagram showing an internal configuration of a fax 100 with telephone function shown in FIG. 1.

FIG. 3 is a view showing a panel configuration of an operation panel 224 in FIG. 2.

FIG. 4 is a view showing an example of a display mode in a display unit 214 in FIG. 3.

FIG. 5 is a block diagram showing an internal configuration of a slave apparatus (cordless handset) 101 shown in FIG. 1.

FIG. 6 is a view showing a panel configuration of the slave apparatus in FIG. 5.

FIG. 7 is a view showing an example of a display mode in a display unit 305 in FIG. 5.

FIG. 8 is a flow chart showing a mail read-out request reception process in the fax 100 with the telephone function shown in FIG. 2.

FIG. 9 is a flow chart showing a character data read-out request transmission process from the slave apparatus 101 shown in FIG. 1.

### DESCRIPTION OF THE PREFERRED EMBODIMENTS

In the following, a wireless communication apparatus embodying the present invention will be explained in detail with reference to accompanying drawings.

The wireless communication apparatus embodying the present invention is constituted of a master apparatus (base station) and a slave apparatus (cordless handset) capable of mutual wireless communication, in which the master apparatus is formed by a telephone set or a fax apparatus with a telephone function. The present embodiment will be explained by an example of a fax having a telephone function.

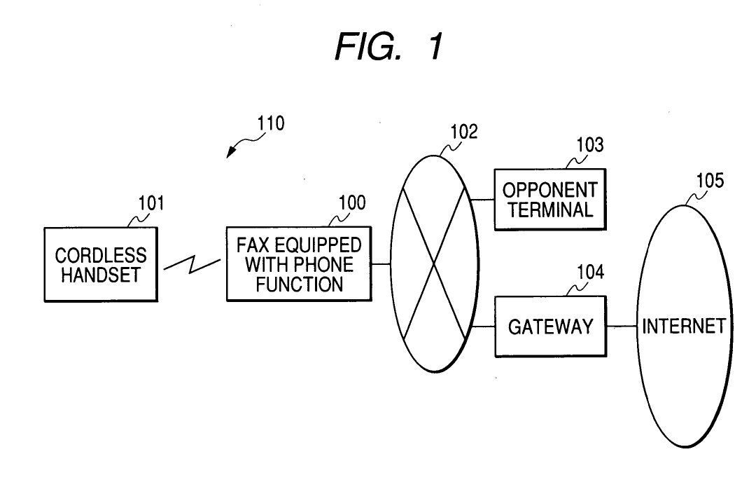

FIG. 1 is a view showing a schematic configuration of a wireless communication apparatus embodying the present invention.

The wireless communication apparatus 110 of the present embodiment is constituted of a fax (facsimile machine) 100 having a telephone function, accommodating a public line 102 such as an analog telephone line or an ISDN line and capable of wireless communication as a master apparatus (base station), and a slave apparatus (cordless handset) 101 capable of wireless communication with the fax 100 with the telephone function. The fax 100 with the telephone function is provided with a telephone function, a browsing function, a speech synthesizing function for character data, and also a mail function capable of transmitting and receiving character data (character message). The public line 102 also accommodates a counterpart terminal 103. The public line 102 is also connected with an internet 105 through a gateway (GW) 104, which executes a data conversion process between the public line 102 and the internet 105. In the internet 105, information can be obtained by accessing to a desired server through a provider.

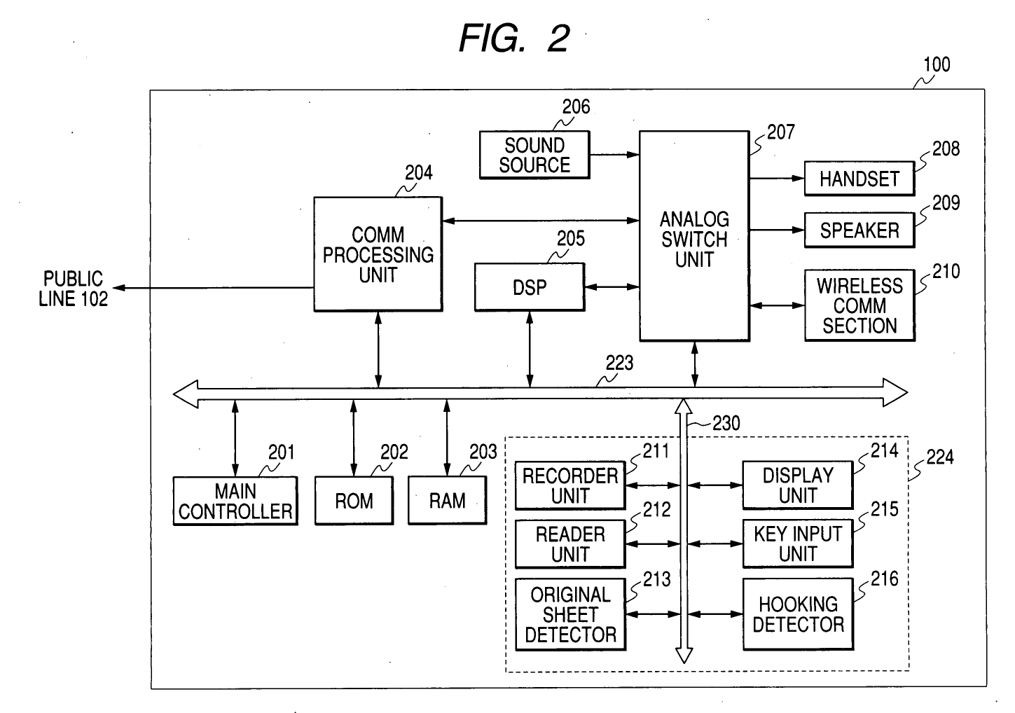

FIG. 2 is a block diagram showing an internal configuration of the fax 100 with the telephone function shown in FIG. 1.

Referring to FIG. 2, the fax 100 with the telephone function is provided with a main controller 201, a ROM 202, a RAM 203, a communication processing unit 204 connected by a wireless communication with the public line 102, a DSP (digital signal processor) 205, an analog switch 207, and an operation unit 224, and these units are mutually connected through a data bus 223. The analog switch 207 is connected to the communication processing unit 204 and the DSP 205, and the analog switch 207 is connected to a sound source 206, a handset 208 for speech input/output, a speaker 209 for outputting a sound of a received call and stored speech data and for monitoring a fax communication, and a wireless communication section 210 for executing a wireless communication with the slave apparatus 101.

The operation unit 224 is provided with a recorder 211, a reader 212, an original sheet detector 213, a display unit 214, a key input unit 215 and a hooking detector 216, which are mutually connected by a data bus 230 which is connected to the data bus 223.

The main controller 201 outputs signals the constituent components through the data buses 223, 230, thereby controlling the constituent components according to such signals. Thus the main controller 201 executes a call process and processes of various service functions according to a call process program stored for example in the ROM 202. As an example of the service functions, when a mail function is activated and a character message is prepared by the user, the main controller 201 stores such character message as text data in the RAM 203.

The communication process unit 204 is an interface for accommodating the public line 102, and, in case of an analog line, is connected to a telephone line of a station exchange (hereinafter called a subscriber line), and is constituted of a polarity matching circuit formed by a diode all-wave rectifying circuit for matching the polarity of a line voltage, a ringer detection circuit connected with the subscriber line of the station exchange for detecting a call signal from the station exchange, a hook switch circuit for forming a circuit loop and sending dialing pulses to the station in response to an off-hook operation, and a transformer circuit for two-four line conversion. The present embodiment is described by an analog circuit, but a configuration based on a digital line such as ISDN or an ADSL line is also easily attainable.

The DSP 205 is provided with a data modem function for executing mail transmission/reception processes including a call process, a caller ID function for analyzing modem data (number display data), and a speech synthesizing function for outputting a speech signal by a speech synthesis from the character data, and these functions are realized under the control of the main controller 201.

More specifically, the speech synthesizing function executes a speech synthesis of the entered character data under the control of the main controller 201 for supply as an analog speech signal to the analog switch 207. The speech synthesizing function has a speech-synthesizing speaking-out function for converting the character code, entered under the control of the main controller 201, into speech data of 50 sounds. The speech data of 50 sounds are stored in the ROM 202. The speech data may also be stored in an internal memory of the DSP 205.

The ROM 202 stores programs for causing the DSP 205 to execute a data modem function, a facsimile function, a caller ID function and a speech synthesizing function. The ROM 202 may be constituted of an E2PROM or a flush ROM capable of data writing and erasing.

The RAM 203 is a memory to be used by the main controller 201, in the mail transmission/reception including a call making process. Different from the ROM 202, it stores temporary data. The RAM 203 is backed up with a battery or the like, and stores a prepared character message, a received character message, a set content of various service functions, and a content registered in the telephone directory. The RAM 203 may also be constituted of an E2PROM as a non-volatile memory.

The sound source 206 stores sound source data such as a hold tone, a call reception melody of 16 chords, and call progress tones such as DT, BT, RBT etc., and outputs an analog signal under the control by the main controller 201. It also outputs a call progress tone such as DT, BT, RBT, etc.

The analog switch 207 executes, under the control of the main controller 201, input/output switching between the signal from the DSP 205 or the analog input/output signal on the sound source 206, the handset 208, the speaker 209 etc., and the communication process unit 204.

The wireless communication section 210 modulates control data and a speech signal into a format capable of wireless transmission for supply to an antenna, and also obtains demodulated data from information received through the antenna, and outputs control data to the main controller 201 and an analog signal to the analog switch 207.

In the following, components constituting the operation unit 224 will be explained.

The recorder 211, provided with known printing means such as a thermal or thermal transfer printer, a laser beam printer or an ink jet printer, decodes MH, MR or MMR encoded digital data and executes a printing employing such decoded data as print data.

The reader 212, provided with known original reading means such as a CCD or a contact sensor array, converts the read analog data into digital data and encodes thus converted digital data by a known encoding method such as MH, MR or MMR.

The original sheet detector 213 detects presence or absence of an original to be transmitted on the reader 212 and informs the main controller 201 of the result.

The display unit 214 displays HTML information received from an internet server, and displays a time and a status such as a line status or an error on the communication, and is principally constituted of a liquid crystal display. The display unit 214 also displays a character message entered by the key input unit 215 and a received character message. It further displays set contents of various service functions of the telephone.

The key input unit 215 is constituted of dial keys for entering a dial number and an URL with keys 0 to 9, * and # and also entering alphabets and symbols utilizing these keys, a transmission/reception key for controlling facsimile transmission and reception, an off-hook key for on/off controlling the line, a hold key, a select key for a function setting etc.

It functions as character input means for entering and editing a character message at a mail transmission. The key input unit 215 is also used in case of executing a character message transmission or reception process by activating a mail function. Also a speech output of a character message prepared by the mail function or of a received character message is achieved by operating predetermined keys of the key input unit 215.

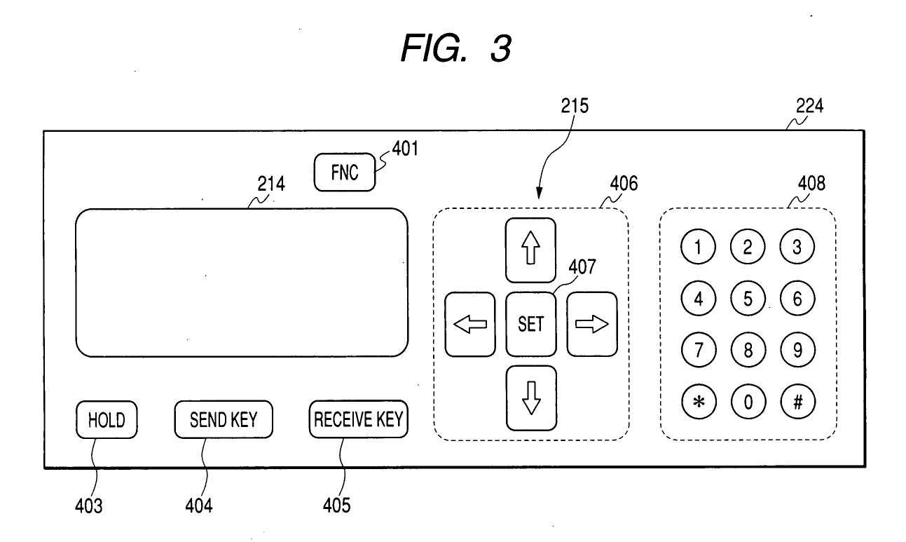

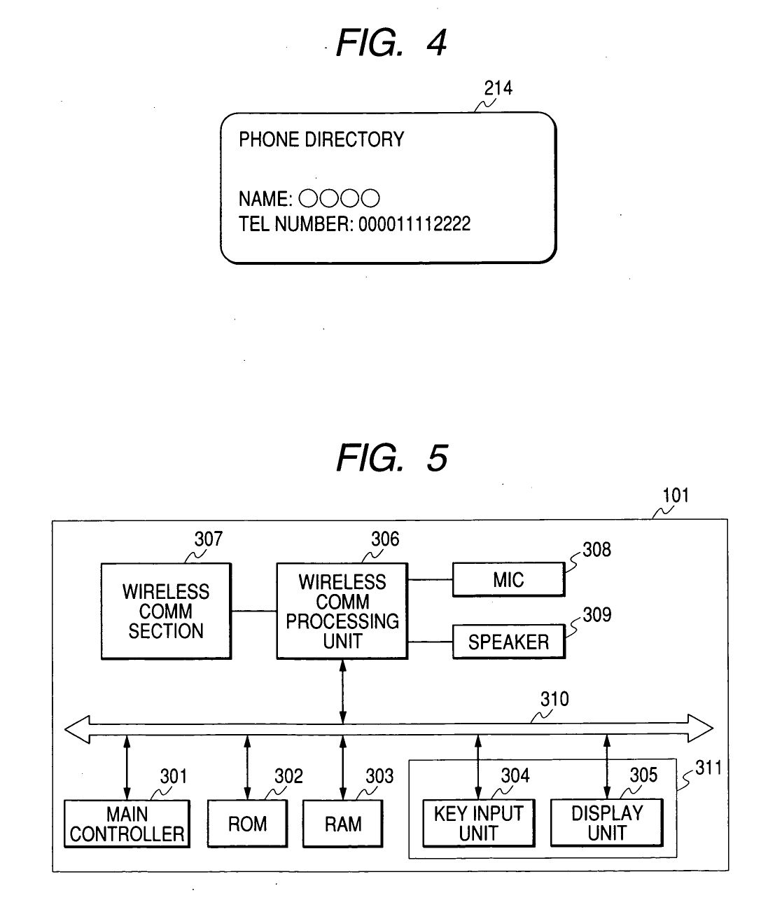

The display unit 214 and the key input unit 215 are incorporated on a panel of the operation unit 224 as shown in FIG. 3. Referring to FIG. 3, the keys belonging to the key input unit 215 include a select 401 for function setting, a hold key 403, a transmission key 404 and a reception key 405 for controlling facsimile transmission and reception, an off-hook key (ten-key) 406 for on/off controlling the line, and numeral keys 408. An example of display in the display unit 214 is shown in FIG. 4.

The hook detector 216 controls the on/off state of the line by detecting the on/off state of the handset 208.

When a transmission operation for the character message is executed, the main controller 201 loads a data modem control program stored in the ROM 202 and controls the DSP 205 as a data modem. It reads data of a designated character message from the character messages stored in the RAM 203, and executes a character message transmitting process. Also the main controller 201, upon detecting a speech output operation for a prepared character message, activates a speech synthesizing program in the ROM 202 and sets the speech synthesizing function in the DSP 205. Then predetermined character data in the RAM 203 are outputted to the speech synthesizing function in the DSP 205 for speech synthesis, and a speech output is made through the analog switch 207 to the speaker 209 and the wireless communication section 210.

Also at a mail reception, the main controller 201 upon receiving a character message by controlling the DSP 205 as a data modem stores such data as text data in the RAM 203. The main controller 201, upon receiving a command for confirming the content of the character message received in the master apparatus, displays the corresponding character data on the display unit 214. Also upon detecting a speech output command for the received character message, the main controller 201 outputs such character data to the DSP 205, set at the speech synthesizing function as explained in the foregoing to execute speech synthesis, thereby executing a speech output from the speaker 209 through the analog switch 207.

Also upon receiving a read-out command for a character message received by a remote operation of the slave apparatus, it controls the DSP 205 and the analog switch 207 thereby outputting a synthesized speech signal from the DSP 205 to the wireless communication section 210.

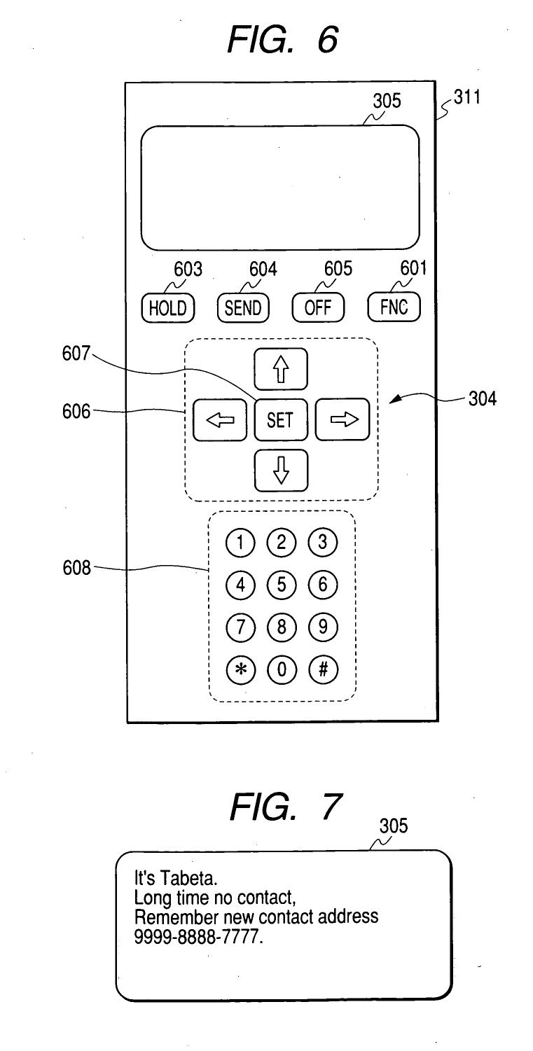

FIG. 6 is a block diagram showing an internal configuration of the slave apparatus 101 in FIG. 1.

Referring to FIG. 5, the slave apparatus 101 is provided with an operation unit 311 including a main controller 301, a ROM 302, a RAM 303, a key input unit 304, and a display unit 305, and a wireless communication process unit 306, and these components are mutually connected through a data bus 310. The slave apparatus 101 is further provided with a wireless communication section 307, a microphone 308 and a speaker 309 respectively connected to the wireless communication process unit 306.

The main controller 301 controls the entire wireless telephone unit 101. The ROM 302 is constituted of a ROM storing a control program for the main controller 301, an EEPROM storing a call sign (system ID) of the present wireless communication system and a sub ID of the wireless telephone, and a flush ROM for storing character data and telephone directory data when a mail is received from the master apparatus. Then RAM 303 serves as a work area for control in the process of the main controller 301.

The key input unit 304 is constituted of function keys such as dial keys for entering a dial number etc., an external connection key, a hold key, a speaker key, and a telephone directory key. The display unit 305 displays a call reception, a dial number entered from the key input unit 304, a status of use of the public line etc.

The key input unit 304 and the display unit 305 are incorporated on a panel of the operation unit 311 as shown in FIG. 6. Referring to FIG. 6, the keys belonging to the key input unit 304 include a select 601 for function setting, a hold key 603, a send key 604 and an off key 605 for controlling facsimile transmission and reception, an off-hook key (ten-key) 606 for on/off controlling the line, and numeral keys 608. An example of display in the display unit 305 in FIG. 6 is shown in FIG. 7.

The wireless communication process unit 306 includes a modem compander, and a secret talk/amplifier function, and enables transmission/reception of control data and a speech signal. It transmits a modulated signal from the wireless communication process unit 306 to the master apparatus through the wireless communication section 307 to be explained later, and also demodulates the modulation signal from the wireless communication section 307 thereby outputting the control signal to the main controller 301 and the speech signal to the speaker 309.

The wireless communication section 307, for communication with the fax 100 with telephone function, converts the modulated signal from the wireless communication process unit 206 into a format capable of wireless transmission for supply to an antenna, and also obtains a modulated signal from a signal, received through the antenna for supply to the wireless communication process unit 306. The microphone 308 executes an input of a communication speech signal, and the speaker 309 provides a loud output of the speech signal and a call reception tone.

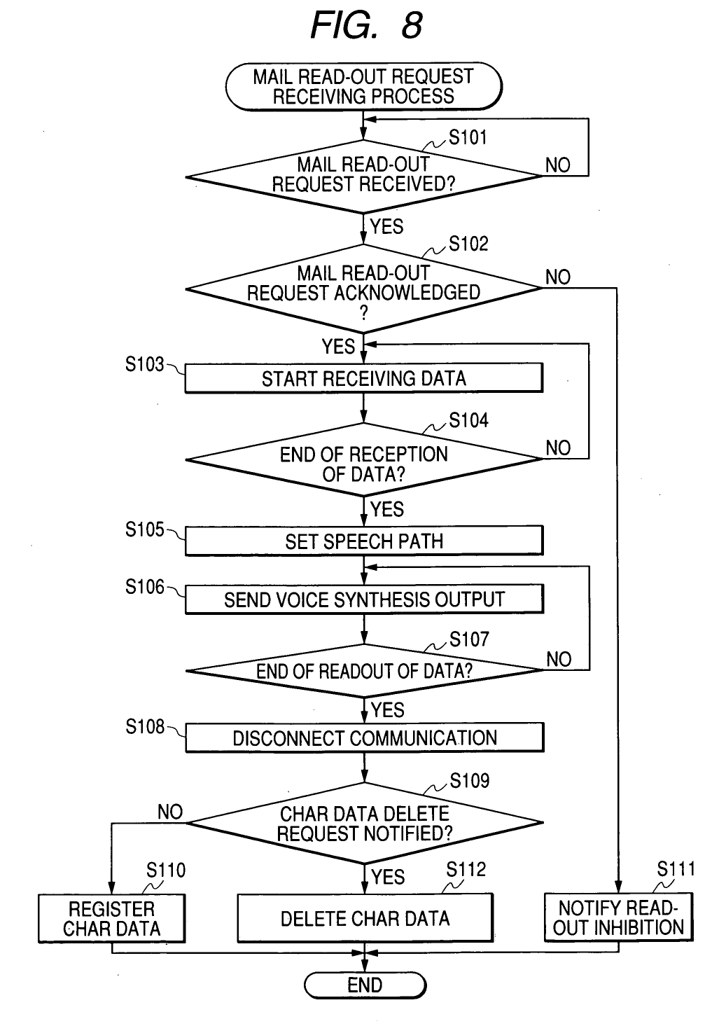

FIG. 8 is a flow chart of a mail read-out request reception process in the fax 100 with telephone function shown in FIG. 2.

Character data herein mean a registered content of the telephone directory registered in the slave apparatus 101 and text data of an e-mail stored therein. The e-mail stored in the slave apparatus 101 means, in case the fax 100 (master apparatus) alone has an e-mail address, an e-mail received in the fax 100 and transferred therefrom to the slave apparatus 101 so as to be readable therein in response to an instruction from the slave apparatus 101, or, in case the slave apparatus 101 also has an e-mail address therefor, an e-mail received by the fax 100 and transferred to the slave apparatus 101 through the fax 100. Also in case the slave apparatus 101 can be used as a portable telephone and has its own e-mail address, the character data is an e-mail received by a direct connection to a mail server without via the fax 100.

In the present process, the fax 100 (master apparatus) with telephone function of the present embodiment executes a process of receiving character data from the slave apparatus 101 and a speech synthesis on the received character data.

Referring to FIG. 8, when the main controller 201 receives a mail read-out request signal from the slave apparatus 101 through the data bus 223 (YES in a step S101), the main controller 201 discriminates whether or not to accept the mail read-out request by confirming the available state of the DSP 205 and the RAM 203 (step S102). In case the mail read-out request cannot be accepted because of the internal resources, a notice for inhibiting the read-out of the character data from the slave apparatus 101 is given to the slave apparatus 101, and the wireless communication section 210 is controlled to disconnect the wireless link with the slave apparatus 101 (step S111) whereupon the present sequence is terminated.

On the other hand, in case the step S102 identifies that the mail read-out request can be accepted, a wireless data reception is initiated (step S103). In this operation, the main controller 201 controls the wireless communication section 210 to extract character data in the control data from the wireless communication section 210, and stores such character data in the RAM 203.

Then, upon receiving a data transmission completion information from the slave apparatus 101 through the wireless communication section 210 (step S104), the main controller 201 controls the analog switch 207 to execute a setting for outputting a speech path (step S105). After the setting, the character data information stored in the RAM 203 is transferred to the DSP 205 for executing a speech synthesizing process, whereby an output of the speech synthesis is transmitted to the slave apparatus 101 (step S106). The main controller 201, upon receiving a reading completion confirmation from the slave apparatus 101 (step S107), terminates the speech synthesizing process and controls the wireless communication section 210 thereby disconnecting the communication with the slave apparatus 101 (step S108).

In a succeeding step S109, there is discriminated whether a character data deletion request has been informed from the slave apparatus 101, and, if not informed, the character data temporarily stored in the RAM 203 are registered (step S110). In case the character data deletion request has been informed, all the character data stored in the RAM 203 are deleted (step S112).

According to the process shown in FIG. 8, when a mail read-out request from the slave apparatus 101 is accepted (YES in the step S102), a speech synthesis is executed and the output thereof is transmitted to the slave apparatus 101 (step S106), and, in the absence of a character data deletion request from the slave apparatus 101 (NO in the step S109), the character data temporarily stored in the RAM 203 are registered (step S110). In the presence of the character data deletion request (YES in the step S109), all the character data stored in the RAM 203 are deleted (step S112).

This process has been described to be executed according to a request from the slave apparatus 101, but it is also easily possible to render the storage and the deletion selectable, by a default setting in the fax 100 with telephone function.

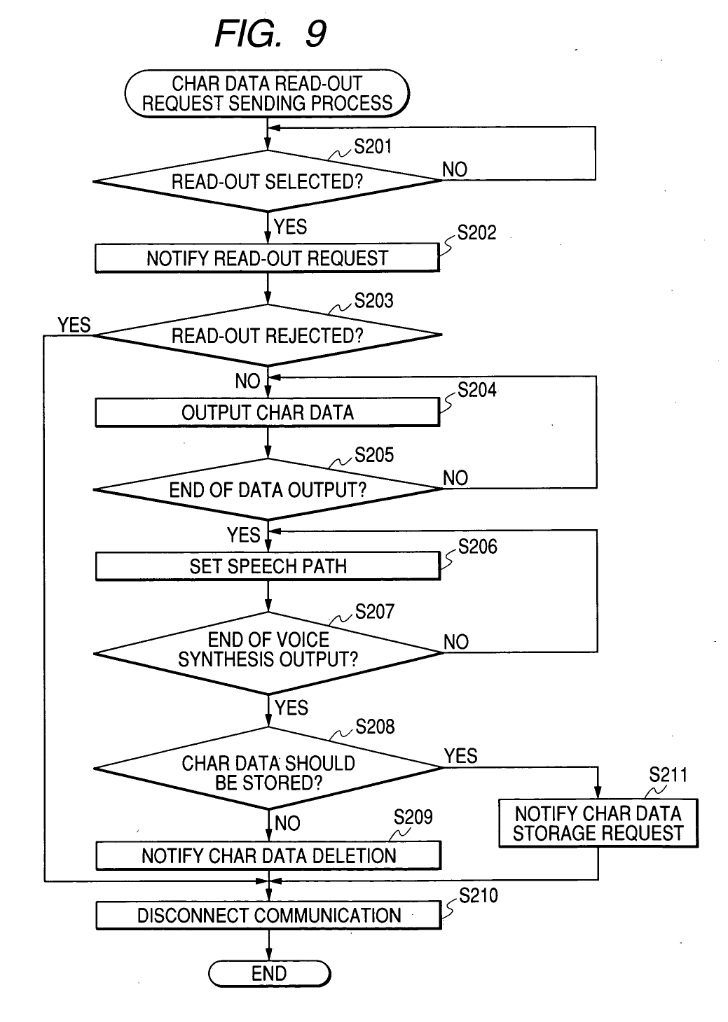

FIG. 9 is a flow chart showing a character data read-out request transmission process from the slave apparatus 101 in FIG. 1.

Referring to FIG. 9, when the function key 601 of the key input unit 304 is depressed to select a mail read-out (YES in step S201), the character data (received mail) stored in the RAM 303 are displayed from a head portion on the display unit 305 and the sequence proceeds to a step S202. Thus, there is given a display “It is Tabeta. Long time no contact. Remember new contact number 9999-8888-7777” as shown in FIG. 7.

Similarly, when the function key 601 of the key input unit 304 is depressed to select a telephone directory function, the main controller 301 displays the telephone directory data, stored in the RAM 303, from the head portion on the display unit 305. In this operation, there are displayed a name (Canon) and a telephone number (000011112222) as shown in FIG. 6.

Then the main controller 301, in synchronization with the display process, controls the wireless communication process unit 306 to transmit a communication request through the wireless communication section 307 to the fax 100, and, in response, the main controller 201 of the fax 100 controls the wireless communication section 210 to initiate a wireless link connection with the slave apparatus 101, whereby the wireless communication process unit 306 of the slave apparatus 101 establishes, through the wireless communication section 307, the wireless link with the wireless communication section 210 of the fax 100 and informs the fax 100 of the character data read-out request (step S202).

Then there is discriminated whether a notice for inhibiting the read-out has been sent from the fax 100 in response to the read-out request (step S203), and, if sent, the main controller 301 controls the wireless communication process unit 306 to disconnect the wireless link with the fax 100 step S210), thereby terminating the sequence.

In case a response accepting the read-out has been received from the fax 100 in response to the read-out request as a result of discrimination in the step S203 (NO in step S203), the main controller 301 transfers the character data in the RAM 303 to the wireless communication process unit 306 and transmits such data in a wireless frame to the fax 100 (step S204). After the completion of the data output (YES in step S205), the main controller 301 sets a speech path for an output from the speaker 309 of a speech-synthesized sound given from the fax 100 step S206).

Thus a speech signal transmitted from the fax 100 is reproduced in the speaker 309, and the user can hear a read-out of a registered content of the telephone directory or an e-mail, stored in the slave apparatus, of which read-out has been instructed by the user.

Upon completion of the output of the speech synthesis in the fax 100 (YES in step S207), the main controller 301 discriminates whether or not to store the character data, transferred to the fax 100, at the disconnecting operation (step S208). Such setting may be set as a default state for the function key 601 in the slave apparatus, or may be selected at the disconnecting operation.

According to the discrimination in the step S208, in case the transferred character data are to be stored in the fax 100, a character data storage request is informed to the fax 100 through the wireless communication process unit 306 (step S211), but in case the transferred character data are to be deleted, a character data deletion request is sent to the fax 100 under the control of the wireless communication process unit 306 (step S209), whereupon the wireless link is disconnected (step S210) and the sequence is terminated.

According to the process shown in FIG. 9, when a mail read-out is selected in the slave apparatus 101 (YES in the step S201), character data are outputted to the fax 100 (step S204). After the completion of the speech synthesis output by a speech signal generated by a speech synthesis in the fax 100 (YES in the step S207), a character data storage request is sent to the fax 100 in case the character data are to be stored (step S211), or a character data deletion request is sent to the fax 100 in case the character data are not to be stored (step S209).

In the present embodiment there is considered a low-power cordless system, but it is also easily possible to construct a digital cordless system.

The present invention can be realized by supplying a computer or a CPU with a program of a software realizing the functions of the aforementioned embodiment (matching the flow charts shown in FIGS. 8 and 9) and reading and executing thus supplied program by the computer or the CPU.

In such case, the program may be directly supplied from a recording medium storing such program, or by downloading from another unillustrated computer or a database connected to an internet, a commercial network or a local area network.

Such program may be formed by object codes, program codes executed by an interpreter, or script data supplied to the OS (operating system).

The present invention can also be realized by supplying a computer or a CPU with a storage medium storing a program of a software realizing the functions of the aforementioned embodiment, and reading and executing the program stored in the memory medium by such computer or such CPU.

In such case, the program codes read from the storage medium constitute the functions of the embodiment, and the storage medium storing the program codes constitutes the present invention.

The storage medium storing the program codes can be, for example, a ROM, a RAM, an NV-RAM, a floppy (registered trade name) disk, a hard disk, an optical disk (registered trade name), a magentooptical disk, a CD-ROM, an MO, a CD-R, a CD-RW, a DVD-ROM, a DVD-RAM, a DVD-RW, a DVD+RW, a magnetic tape, or a non-volatile memory card.

The functions of the foregoing embodiment can also be realized not only in case where a computer executes read program codes, but also a case where an OS or the like functioning on the computer executes all the actual processes or a part thereof under the instruction of the program codes.

As above-mentioned in the present invention, as a master apparatus executes speech synthesis for character data based on the character data transmitted from a slave apparatus to the master apparatus and the slave apparatus outputs a speech based on a speech signal transmitted from the master apparatus, the character data stored in the slave apparatus can be read out therein without providing the slave apparatus with a speech synthesizing function.

This application claims priority from Japanese Patent Application No. 2003-343719 filed on Oct. 1, 2003, which is hereby incorporated by reference herein.

1. A wireless communication apparatus constituted of a master apparatus accommodating a public line and a slave apparatus capable of wireless communication with said master apparatus,
wherein said master apparatus comprises speech synthesis means which executes a speech synthesis on character data and outputs a speech signal, and transmission means which transmits said outputted speech signal to said slave apparatus, and
said slave apparatus comprises storage means which stores character data, transmission means which transmits said stored character data to said master apparatus, request means which requests the speech synthesis means of said master apparatus to execute a speech synthesis on said transmitted character data, and speech output means which outputs a speech based on the speech signal transmitted from said master apparatus.

2. A wireless communication apparatus according to claim 1, wherein said character data are data of a telephone directory.

3. A wireless communication apparatus according to claim 1, wherein said character data are data of a received mail.

4. A wireless communication apparatus according to any one of claims 1 to 3, wherein said master apparatus further comprises another storage means which stores character data transmitted from said slave apparatus.

5. A wireless communication apparatus according to claim 4, wherein said another memory means stores said character data according to a setting by said master apparatus.

6. A communication method for a wireless communication apparatus constituted of a master apparatus accommodating a public line and a slave apparatus capable of wireless communication with said master apparatus, wherein:
a speech synthesis step which executes a speech synthesis on character data and outputs a speech signal, by said master apparatus;
a transmission step which transmits said outputted speech signal to said slave apparatus, by said master apparatus;
a storage step which stores character data, by said slave apparatus;
a transmission step which transmits said stored character data to said master apparatus, by said slave apparatus;
a request step which requests the speech synthesis means of said master apparatus to execute a speech synthesis on said transmitted character data, by said slave apparatus; and
a speech output step which outputs a speech based on the speech signal transmitted from said master apparatus, by said slave apparatus.

7. A wireless communication program for causing a computer to execute a communication method for a wireless communication apparatus constituted of a master apparatus accommodating a public line and a slave apparatus capable of wireless communication with said master apparatus, comprising:
a speech synthesis module which executes a speech synthesis on character data and outputs a speech signal, for said master apparatus;
a transmission module which transmits said outputted speech signal to said slave apparatus, for said master apparatus;
a storage module which stores character data for said slave apparatus;
a transmission module which transmits said stored character data to said master apparatus for said slave apparatus;
a request module which requests the speech synthesis means of said master apparatus to execute a speech synthesis on said transmitted character data for said slave apparatus; and
a speech output module which outputs a speech based on the speech signal transmitted from said master apparatus, for said slave apparatus.
